(19) United States
(12) Patent Application Publication
(10) Pub. No.: US 2025/0322996 A1
(43) Pub. Date: Oct. 16, 2025

(54) Energy Storage Assembly Having Energy Storage Modules

(71) Applicant: Systematic Power Manufacturing, LLC, Knoxville, TN (US)

(72) Inventors: D. Alexander Patsos, Canajoharie, NY (US); John E. Krohn, Troy, NY (US); Glenn T. Bertrand, Davenport, NY (US); Chad E. Hall, Walton, NY (US); Nathan R. Talbot, Gilbertsville, NY (US)

(73) Assignee: Systematic Power Manufacturing, LLC, Knoxville, TN (US)

(21) Appl. No.: 19/175,654

(22) Filed: Apr. 10, 2025

Related U.S. Application Data
(60) Provisional application No. 63/632,806, filed on Apr. 11, 2024.

(51) Int. Cl. H01G 11/12; H01G 11/18; H01G 11/78; H01M 10/42; H01M 10/48; H01M 10/613; H01M 10/643; H01M 10/6563; H01M 50/213; H01M 50/224; H01M 50/296; H01M 50/509

(52) U.S. Cl. CPC H01G 11/12; H01G 11/18; H01G 11/78; H01M 10/425; H01M 10/482; H01M 10/486; H01M 10/613; H01M 10/643; H01M 10/6563; H01M 50/213; H01M 50/224; H01M 50/296; H01M 50/509; H01M 2010/4278

(57) ABSTRACT

An energy storage assembly for storing electrical energy. The energy storage assembly comprises a plurality of cabinets, with each cabinet having a positive terminal and a negative terminal for receiving and delivering electrical energy. Each cabinet also has energy storage modules. The energy storage modules are arranged in vertical stacks within the cabinets. The modules each comprise two or more rows of energy storage cells, with each row of energy storage cells having its own positive terminal and negative terminal. The rows of energy storage cells within each module reside electrically in series. At the same time, the energy storage modules reside electrically in series between the positive terminal and the negative terminal of its respective cabinet. Additionally, each of a plurality of cabinets resides electrically in series, forming strings. Cooling systems force air from one end of the cabinet to the other end of the cabinet.

### CROSS REFERENCE TO RELATED APPLICATIONS

This application claims the benefit of U.S. Ser. No. 63/632,806 filed Apr. 11, 2024. That application is entitled “Cooling System For An Energy storage assembly” and is incorporated herein in its entirety by reference.

### STATEMENT REGARDING FEDERALLY SPONSORED RESEARCH OR DEVELOPMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present invention relates to energy storage devices. More specifically, the present disclosure relates to an energy storage module wherein ultra-capacitors are housed in series. Additionally, the present disclosure relates to an energy storage module wherein rows of ultra-capacitor cells are spaced apart for cooling. Further, the present disclosure pertains to an energy storage system designed to serve as a source or sink of power as needed for a local grid.

### Technology in the Field of the Invention

In conventional energy storage assemblies, a plurality of capacitor cells, ultra-capacitor cells, batteries, or other energy storage devices are loosely held together within a housing. Co-owned U.S. Pat. No. 9,892,868 demonstrates a housing system for a plurality of ultra-capacitor cells which serve to securely store the energy storage devices for safe transport.

The '868 patent beneficially offered a physical arrangement for energy storage devices wherein a small array of capacitor cells could be placed into a housing, with the housing offering two electrodes. An energy storage assembly was formed that served as a portable source of energy that could power, for example, a vehicle.

Ultra-capacitors, also referred to as electric double-layer capacitors (EDLC), are a class of energy storage devices capable of storing large amounts of energy. Specifically, ultra-capacitors can store 10 to 100 times more energy per unit volume or mass than their electrolytic equivalents. They can also charge/discharge much faster than batteries. Ultra-capacitors are sometimes termed “super” because of the high surface area of their electrodes and the very small separation distance between the positive and negative charge.

It is desirable to take the concept of a small grouping of ultra-capacitor cells as taught in the '868 patent, and scale up into a large array of ultra-capacitors to form energy storage devices offering far more power. A number of such energy storage devices may then be used as energy modules, with the energy modules being stacked together in series within a cabinet to form a larger energy storage assembly offering a much greater potential.

### BRIEF SUMMARY OF THE INVENTION

An energy storage assembly having a plurality of energy storage modules is provided herein. Each energy storage module has a plurality of energy storage cells arranged in rows. Preferably, each energy storage cell is an ultra-capacitor cell.

In one embodiment, the energy storage assembly first comprises a cabinet. The cabinet may have a frame that supports side walls and a door. For example, the cabinet may have a first side wall, a second side wall opposite the first side wall, and a door. Optionally, the cabinet includes a top surface and a bottom surface. Each of the first side wall and the second side wall, along with the top and bottom, are fabricated from a metal material, thereby forming the cabinet into a Faraday cage.

The energy storage assembly also has a first energy storage module. The first energy storage module resides within the cabinet, and has an input (or positive) terminal for receiving and delivering electrical energy.

Similarly, the energy storage assembly has a second energy storage module. The second energy storage module also resides within the cabinet, and has an output (or negative) terminal for receiving and delivering electrical energy.

The energy storage assembly further comprises a plurality of intermediate energy storage modules. In one aspect, the intermediate energy storage modules are stacked in vertical arrangement along the cabinet between the first and the second energy storage modules. Alternatively, the intermediate energy storage modules are placed in a horizontal arrangement along the cabinet between the first and the second energy storage modules. In either instance, the plurality of intermediate energy storage modules comprises at least two energy storage modules, and more preferably at least four modules.

Each of the first, the second, and the intermediate energy storage module comprises:
two or more rows of energy storage cells, with the energy storage cells being connected electrically in series; and
at least two bulkheads having through-openings, wherein each through-opening receives a respective energy storage cell to support a row of energy storage cells.

Each of the rows of energy storage cells within each energy storage module has its own positive terminal and negative terminal. The energy storage cells may comprise batteries, capacitors, or a combination thereof. Preferably, each energy storage cell is an ultra-capacitor, with the energy storage cells being welded end-to-end for support and connectivity.

In one aspect, each bulkhead comprises a reservoir residing below one or more of the through-openings. The reservoirs are configured to receive fluid from one or more of the energy storage cells. This may occur, for example, during an episode of leakage, or venting.

The energy storage assembly also includes a cooling system. The cooling system is connected to the cabinet and is configured to force air from a first end of the cabinet to a second end of the cabinet. Forcing air from a first end of the cabinet to a second end of the cabinet causes air to flow across the energy storage cells.

The cooling system is preferably an open-loop cooling system that utilizes a fan to blow the forced air. In one aspect, the fan resides within a fan housing on the cabinet. The first end of the cabinet is at an upper end of the cabinet, and the second end of the cabinet is at a lower end of the cabinet. Preferably, the fan housing resides at the upper end of the cabinet and is arranged to pull air upward from the cabinet. Alternatively, forced air may be provided by an external supply.

The energy storage modules reside electrically in series between the positive terminal of the energy storage assembly and the negative terminal of the energy storage assembly. In one aspect, this is done through busbar connections. For example, each of a first portion of the busbars connects the negative terminal of a first energy storage module with the positive terminal of an adjacent second energy storage module. At the same time, each of a second portion of the busbars connects the negative terminal of a first row of energy storage cells to the positive terminal of an adjacent second row of energy storage cells.

Each energy storage module comprises at least two rows of energy storage cells, and each row comprises at least two energy storage cells connected end-to-end. In one embodiment, each energy storage module comprises eight rows of energy storage cells. Each row of energy storage cells comprises six energy storage cells positioned end-to-end. In this way, a 6×8 array is provided.

In one embodiment, the energy storage assembly further comprises at least one temperature sensor associated with each energy storage module. In addition, a bypass switch may be associated with one or more energy storage modules. A module controller may be associated with each energy storage module, wherein each module controller is configured to (i) receive data related to voltage across each energy storage module, and (ii) generate bypass instructions for the bypass switches associated with the respective energy storage module.

The energy storage assembly also includes a cabinet controller. The cabinet controller is configured to (i) receive data from each of the module controllers and, in response, control the bypass switches associated with the energy storage modules. The cabinet controller is designed to be in electrical communication with a power station (including a power sub-station) a micro-grid, or any power conditioning equipment.

A separate energy storage system for storing electrical energy is also provided herein. In this instance, the energy storage system comprises a plurality of energy storage assemblies placed in series, forming a string. In other words, a series of cabinets as described above are electrically joined, forming an energy storage system.

Placement of the energy storage assemblies in series means that the string has two or more cabinets, and preferably 8 or even 10 cabinets. Each cabinet has its own positive terminal for receiving electrical energy, and its own negative terminal for delivering electrical energy.

In this arrangement, each energy storage assembly may comprise a plurality of busbars. Each of a first portion of the busbars connects the negative terminal of a first energy storage module with the positive terminal of an adjacent second energy storage module. At the same time, each of a second portion of the busbars connects the negative terminal of a first row of energy storage cells to the positive terminal of an adjacent second row of energy storage cells.

Each of the plurality of energy storage modules resides on a rack, a shelf or a rail within a cabinet. Preferably each energy storage cell within the modules is an ultra-capacitor cell. The negative terminal of each row of energy storage cells is in electrical connection with a positive terminal of an adjacent row of energy storage cells such that the rows of energy storage cells are in series.

The rows of energy storage cells within each energy storage module and within each cabinet reside electrically in series. Similarly, the energy storage modules in each cabinet reside electrically in series between the positive terminal and the negative terminal of its respective cabinet. And finally, each of the plurality of cabinets resides electrically in series. Thus, the energy storage cabinets deliver electrical energy from cell-to-cell, from row-to-row, and then from module-to-module, all in series.

Preferably, the energy storage assembly comprises at least 10 cabinets, forming a string. Each cabinet holds at least 2 energy storage modules. As noted above, the energy storage modules may be stacked in vertical arrangement within each cabinet, in series. The cabinets may be in electrical communication with a power station or a micro-grid. Each string will have its own string controller.

In one aspect, the cabinet controllers will take all of the data from each module, and compare the data, or readings, to baseline values for temperature and voltage. The data collected by cabinet controllers may be fed to the string controller that monitors data of all cabinets within the string.

It is again noted that each energy storage assembly will have a cooling system. The cooling system is configured to force air from a first end of the cabinet to a second end of the cabinet. The energy storage assemblies each further comprises at least one temperature sensor associated with each energy storage module. The temperature sensors may be thermistor-type devices. The temperature sensors will provide a monitor for component overheating.

As noted, each energy storage assembly, or cabinet, also includes a cabinet controller. Optionally, an auxiliary power system may be provided for each cabinet. The auxiliary power system comprises voltage converters and one or more rechargeable power packs. The rechargeable power packs may be, for example, rechargeable batteries secured to an inside surface of the door.

Each cabinet may consist of five parts: the cabinet enclosure, the ultra-capacitor energy storage modules, the cooling system, the auxiliary power system, and the cabinet controller and its monitoring equipment. Optionally, and as will be discussed further below, each energy storage assembly may also comprise bypass hardware and discharge hardware.

Preferably, the energy storage system will comprise multiple parallel strings, that is, multiple sets of energy storage assemblies. Each string will have its own string controller. The first string controller monitors all energy storage assemblies within the first string; a second string controller monitors all energy storage assemblies within a second string; and so forth. In one aspect, a first string, a second string, and a third string are electrically connected in parallel to form the complete energy storage system. The energy storage system is connected between the direct current (DC) poles of a Modular Multilevel Converter.

### DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an energy storage device of the present invention, in a first embodiment. Each energy storage device comprises an array of ultra-capacitors, forming a module.

FIG. 2 is an end view of the energy storage module of FIG. 1.

FIG. 3 is another perspective view of the energy storage module of FIG. 1, but wherein the components are shown in exploded-apart relation.

FIG. 4 is a perspective view of an energy storage assembly of the present invention, in one embodiment. The energy storage assembly comprises a plurality of modules, stacked vertically within a cabinet.

FIG. 5 is a layout of the controller of the energy storage module of FIGS. 1 through 3. The layout is a set of components placed on a printed circuit board.

FIG. 6 is a circuit diagram that shows a schematic of the electrical connections between multiple energy storage modules within a cabinet.

FIG. 7A is a perspective view of an energy storage device of the present invention, in a second embodiment. The energy storage device again comprises an array of ultra-capacitors, forming a module.

FIG. 7B is a cross-sectional view of the energy storage module of FIG. 7A. The view is taken through one of the bulkheads.

FIG. 7C is a perspective view of the bulkhead of FIG. 7B. Energy storage cells are shown extending through five of the through-openings of the bulkhead, for illustrative purposes.

FIG. 7D is a front plan view of the bulkhead of FIG. 7C. All energy storage cells have been removed from the through-openings. An electrolytic fluid is shown in two fluid reservoirs below corresponding through-openings.

FIG. 8A is a perspective view of a plurality of energy storage modules arranged in vertical stacks, in an alternate embodiment. Each energy storage module comprises an array of ultra-capacitor cells.

FIG. 8B is a side view of the stack of energy storage modules of FIG. 8A.

FIG. 8C is a perspective view of one of the modules of FIG. 8B. In this view, one of the cooling tubes has been removed for illustrative purposes.

FIG. 9A is a perspective view of an energy storage assembly of the present invention, in an alternate embodiment. The assembly employs the energy storage module of FIG. 7A. In this view, the door is opened for illustrative purposes, exposing a 10×2 array of modules within a cabinet.

FIG. 9B is a front plan view of the energy storage assembly of FIG. 9A. Here, the door is again open.

FIG. 10 is a cutaway view of an upper portion of the energy storage assembly of FIG. 9A. A series of discharge resistors is shown.

FIG. 11 is a schematic view of an energy storage system, in one aspect. The energy storage system includes a plurality of strings, placed electrically in parallel, each of which comprises a plurality of energy storage assemblies, placed electrically in series.

### DETAILED DESCRIPTION OF SELECTED SPECIFIC EMBODIMENTS

In the following description, reference is made to the accompanying drawings that form a part thereof, and in which is shown by way of illustration exemplary embodiments in which the present disclosures may be practiced.

Certain features characteristic of the embodiments of the present application are set forth in the appended claims. However, the embodiments themselves and further objectives and advantages thereof, will best be understood by reference to the following detailed description when read in conjunction with the accompanying drawings, wherein:

The present disclosure generally relates to assemblies of energy storage devices. The present disclosure further relates to an open-loop cooling system for an energy storage assembly.

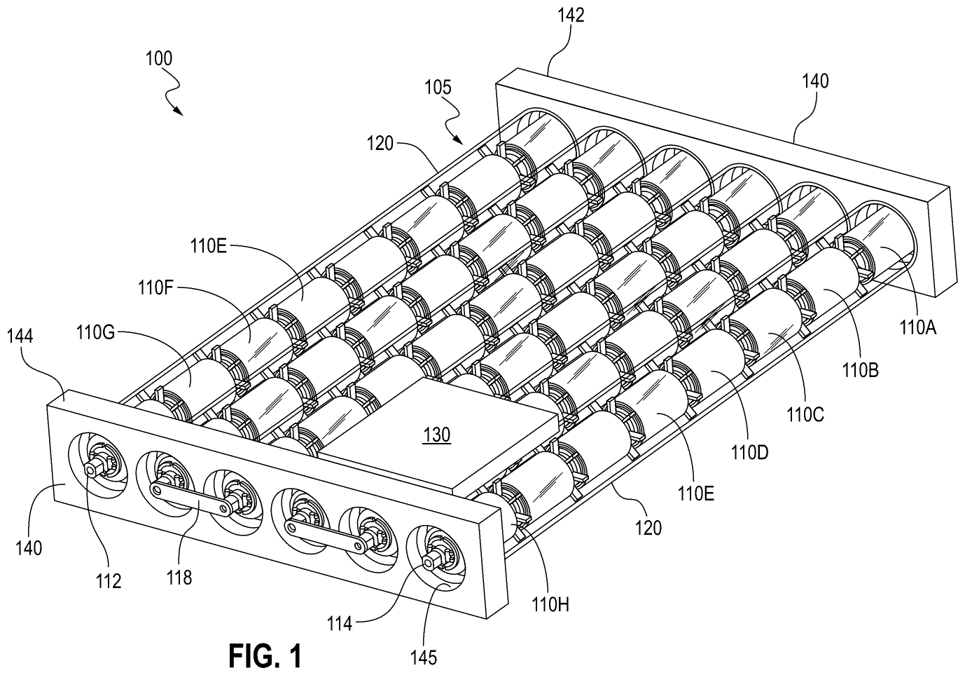

FIG. 1 is a perspective view of an energy storage module 100 of the present disclosure, in one embodiment. The energy storage module 100 includes rows 105 of ultra-capacitor cells 110, with each row 105 of ultra-capacitor cells 110 being housed in an elongated tubular body 120. The elongated tubular bodies 120 serve as cooling tubes and are referred to herein as such.

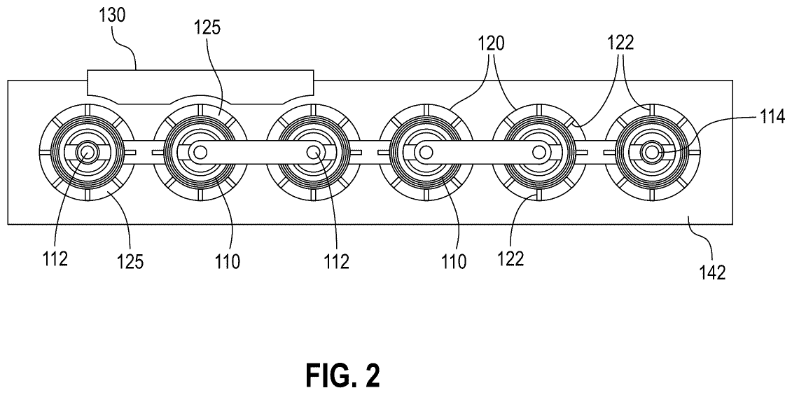

FIG. 2 is an end view of the energy storage module 100 of FIG. 1. Here, a first end plate (or bulkhead) 142 is shown with positive terminals 112 associated with each row 105 of ultra-capacitor cells 110.

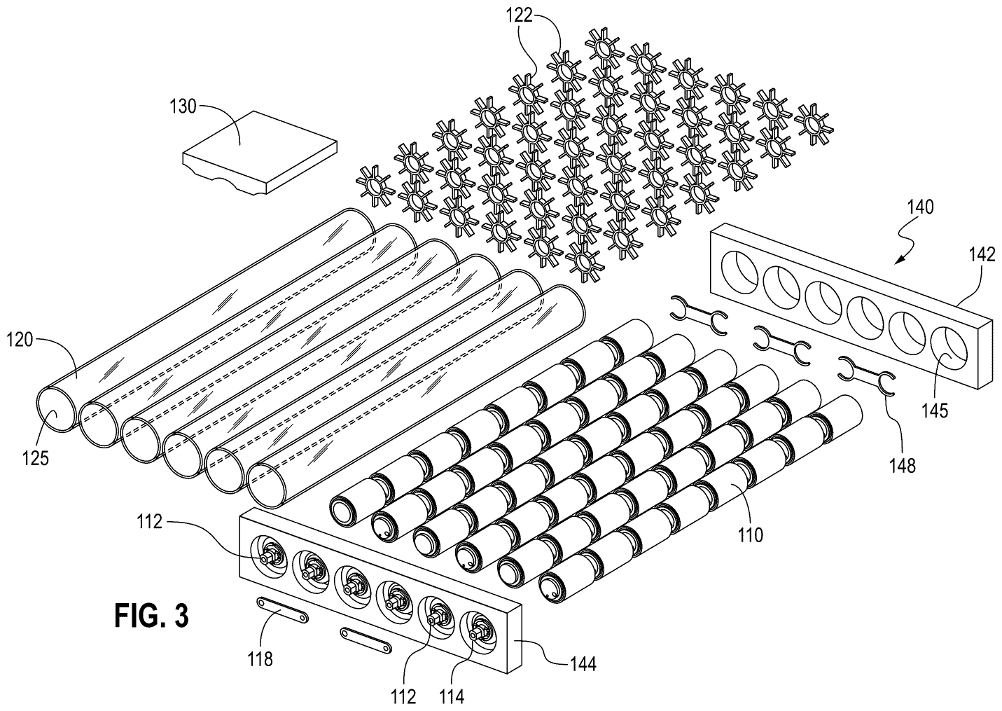

FIG. 3 is another perspective view of the energy storage module 100 of FIG. 1. In this view, the components of the energy storage module 100 are shown in exploded-apart relation.

The energy storage module 100 is designed to be one of a plurality of modules. The energy storage module 100 will be discussed with reference to FIGS. 1, 2 and 3 together.

The energy storage module 100 first comprises a plurality of energy storage cells 110. The energy storage cells 110 are preferably ultra-capacitor cells. The ultra-capacitor cells 110 represent a row 105 of individual ultra-capacitor cells placed electrically in series, with the rows 105 being in side-by-side relation. In the illustrative arrangement of FIG. 1, six rows 105 of ultra-capacitor cells 110 are provided, with each row 105 having 8 individual ultra-capacitor cells 110. The individual ultra-capacitor cells 110 may be designated as cells 110A, 110B, 110C, . . . 110H. Thus, the ultra-capacitor cells 110 are configured in an array providing 6 rows of 8 ultra-capacitor cells 110, in series. This presents a 6×8 array with a total of 48 individual ultra-capacitor cells 110.

It is understood that the array of FIG. 1 is illustrative only, and that a larger or a smaller number of individual energy storage cells 110 may be employed in each row 105, and a greater or smaller number of rows 105 of energy storage cells 110 may be provided. It is also noted that some rows 105 may utilize Lithium-ion batteries or other electrical cells. However, ultra-capacitor cells 110 are preferred. Ultra-capacitors provide a unique balance between power density and energy density that makes ultra-capacitors a preferred choice for grid stabilization.

The energy storage cells 110 may embody a generally cylindrical geometry and are connectable end-to-end to form the rows 105. Each row 105 of energy storage cells 110 will have a positive terminal 112 and a negative terminal 114. Electrical energy is transmitted through the positive terminal 112, into energy storage cell 110A of each row 105, on to energy storage cell 110H of each row 105, and to negative terminal 114. In a preferred arrangement, all energy storage cells 110 are in series, meaning that the negative terminal 114 of one row 105 is in electrical connection with the positive terminal 112 of an adjacent row 105. In this arrangement, busbars 118 may be used to connect the adjacent negative 114 and positive 112 terminals.

Busbars 118 are seen in FIGS. 1 and 3. In these views, the busbars 118 are connected to terminals 112, 114 of adjoining rows 105 of energy storage cells 110. In this arrangement, one terminal, e.g., positive terminal 112, may comprise a threaded hole for receiving a connector for securing a busbar 118. Similarly, one terminal, e.g., negative terminal 114, may comprise a threaded stem for connecting to a nut for securing the respective busbar 118. As an alternative, the electrical connection may be made using a weld bond joining a terminal on each row 105 to one part of a busbar with a successive row 105 with a second part of the busbar 118. Such an arrangement is described in co-owned U.S. Pat. No. 9,892,868, which is incorporated herein in its entirety by reference.

For busbars 118, resistance is a function of length. Reducing the length of each busbar 118 by setting connected terminals near each other reduces overall system resistance. The operator may run power into either the positive side or the negative side of the module 100, so long as the busbars are arranged appropriately to feed current in series.

The rows 105 of ultra-capacitor cells 110 are supported at opposing ends by bulkheads 140. A first bulkhead (or end plate) 142 is provided at a first end of the rows 105 of ultra-capacitor cells 110, while a second bulkhead (or end plate) 144 is provided at a second end of the rows 105 of ultra-capacitor cells 110. Each bulkhead 140 includes a plurality of openings (or apertures) 145 designed to accommodate the positive 112 and negative 114 terminals of the rows 105 of ultra-capacitor cells 110.

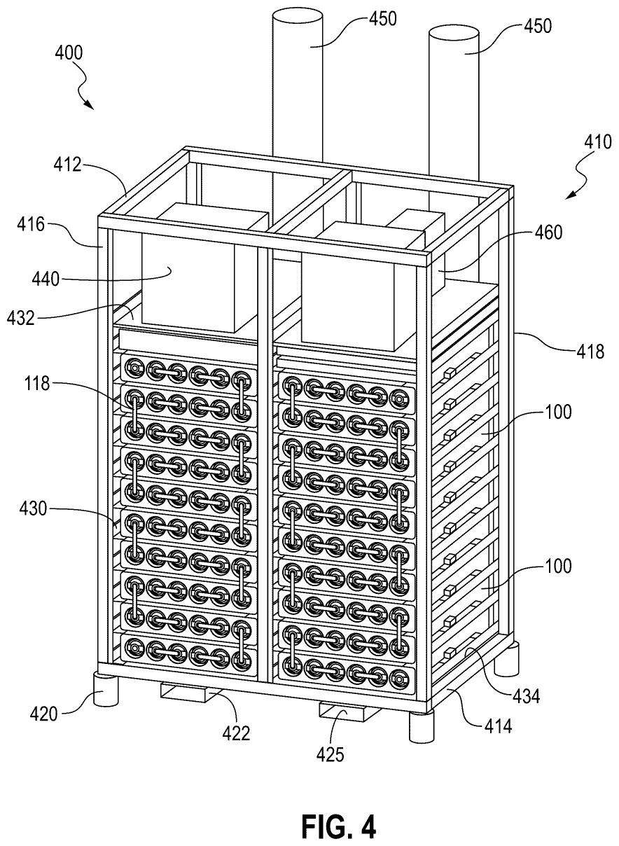

The bulkheads 140 may be fabricated from any composition capable of insulating electricity. Non-limiting examples include a polycarbonate material or a hardened butadiene rubber. Bulkheads 140 manufactured from a polymeric material can offer resistance to shocks and vibrations while preventing electrical shorting between the energy cells 110 and the larger support structure, e.g., cabinet 410 shown in FIG. 4. The design includes sufficient clearance and creepage distances through and over the plastic components to prevent electrical shorting.

Each terminal 112, 114 extends substantially through its corresponding bulkhead 140 via a corresponding aperture 145. The terminals 112, 114 are fabricated from an electrically conductive material so as to transfer electrical energy through a respective bus bar 118 and to an adjoining terminal 114, 112.

As noted, rows 105 of ultra-capacitor cells 110 are housed within cooling tubes 120. The cooling tubes 120 are preferably fabricated from a durable but light-weight, non-conductive material. Non-limiting examples include a translucent polycarbonate material. Each tube 120 may be, for example, between 12 and 36 (305 mm and 914 mm) inches in length, and have an outer diameter (or OD) of between 2 and 4 inches (51 mm and 102 mm). The cooling tubes 120 may be placed along racks (shown at 430 in FIG. 4) in horizontal orientation.

Spacers 122 are provided along the cooling tubes 120. The spacers 122 slide onto or otherwise encompass the outer diameters (or OD) of selected energy storage cells 110. The spacers 122 essentially centralize the individual energy storage cells 110 within the cooling tubes 120. In this way, an annular space 125 is formed between the energy storage cells 110 and an inner diameter (or ID) of the cooling tubes 120. As will be discussed later, the annular space 125 within the cooling tubes 120 receive a gas coolant during operation.

It is understood that it is not necessary for each individual energy storage cell 110 to receive its own spacer 122. Spacers 122 may be employed as needed to preserve the annular space 125. As an alternative, spacers 122 may be placed between selected energy storage cells 110 so long as electrical connection is maintained along the rows 105.

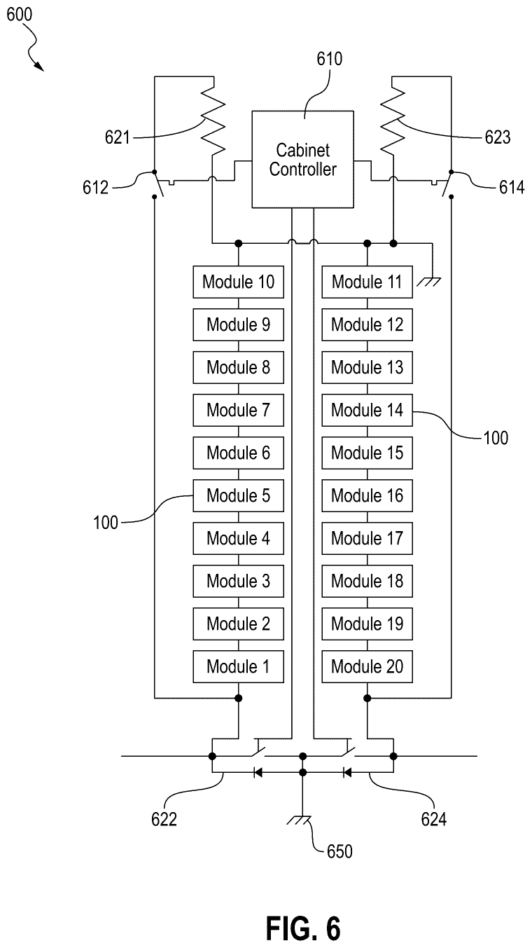

The energy storage module 100 also includes a module controller 130. The module controller 130 monitors the voltages and temperatures of the ultra-capacitor cells 110. Data related to voltage and temperature is sent from the module controllers 130 to a cabinet controller (described below at 610 in connection with FIG. 6).

The ESR and capacitance of every energy storage cell 110 can be calculated, and tracked over time. This allows the module controller 130 to predict when energy storage cells 110 will reach an end of life condition, and prevent cell failure, including venting. Further, the module controller 130 may send records of all collected data in a log server, which can be accessed and reviewed for root cause post-mortem analysis of failures, and to improve the lifetime predictions of cell performance.

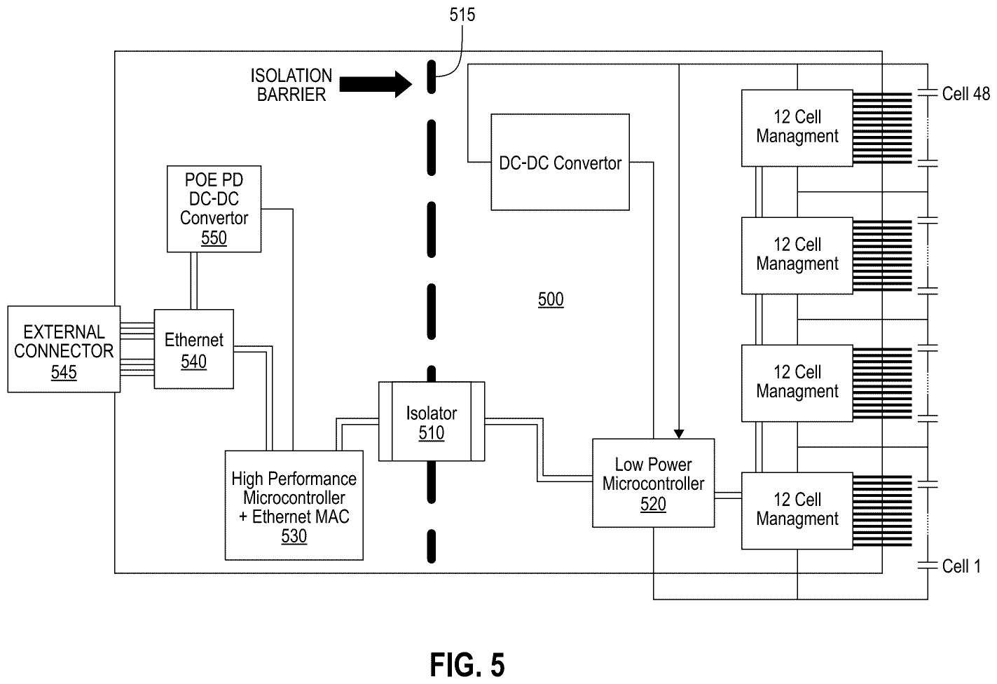

FIG. 5 is a layout of the module controller 130 of the energy storage module 100 of FIGS. 1 through 3. The layout comprises a set of electrical components placed on a printed circuit board 500.

It can be seen that the module controller 130 first includes a Digital Isolator 510. This Digital Isolator 510 is designed to provide an isolated communications bridge. In one aspect, a 5 kV isolation barrier (depicted by dashed line 515) is created along the circuit board 500.

A module controller 520, 530 is provided on each side of the isolated communications bridge 515. Each module controller 520, 530 may be, for example, an ARM 32-bit micro-controller. A first micro-controller 520 is seen on the right side of the communications bridge 515. This may be a low-power micro-controller 520. This first micro-controller 520 is designed to manage cell monitoring and the balancing of the ultra-capacitors 110 in an associated energy storage module 100.

A second micro-controller 530 is seen on the left side of the isolation bridge 515. This is a high performance micro-controller 530 which includes a media-access controller (or MAC). The second micro-controller 530 interfaces with a cabinet controller (shown at 610 in FIG. 6) via a wired Ethernet. An Ethernet interface is indicated at 540. The Ethernet interface 540 is essentially a transceiver component for transmitting and receiving data, or so-called Ethernet frames. An external connection to the Ethernet interface is provided at 545.

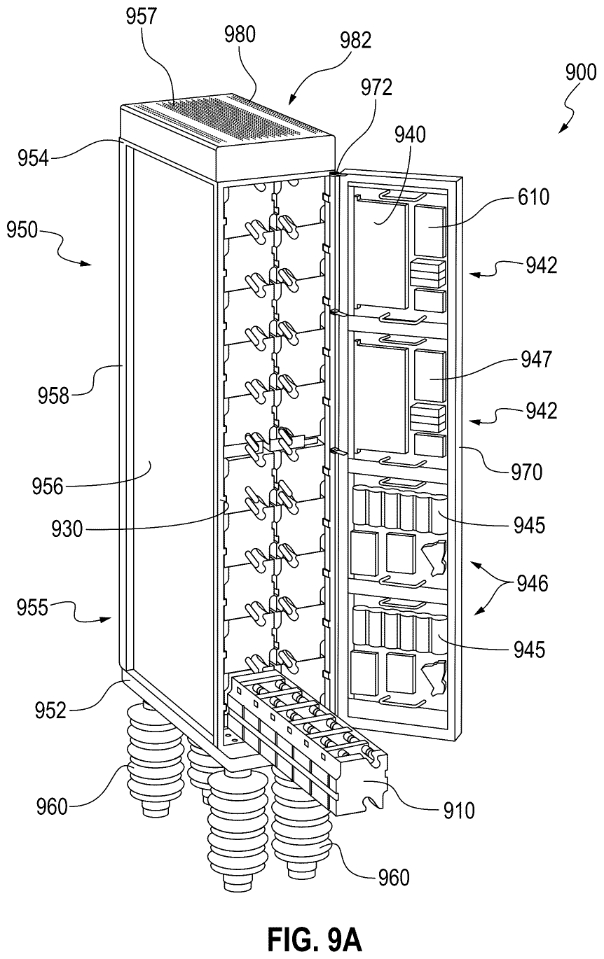

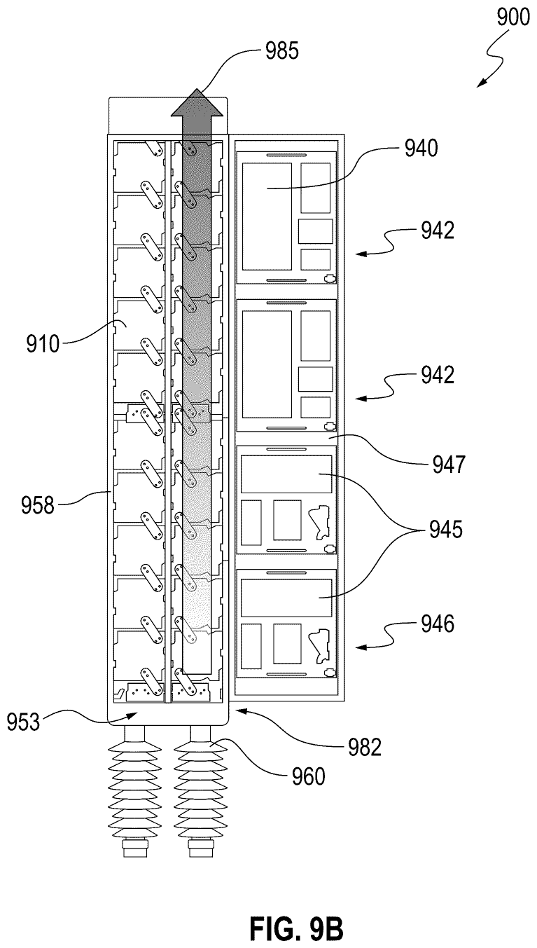

The Ethernet interface 540 is connected to a Power-over-Ethernet Powered Device, indicated as a PoE PD 550. The PoE PD 550 receives electrical power from a connected Power Sourcing Equipment over existing copper Ethernet cables. The PoE PD 550 component includes a DC to DC converter. With a PoE Power Sourcing Equipment (PSE) switch (shown in FIG. 9A at 940), power and communications are assured with the second module controller 530 while the first module controller 520 is powered by the energy storage module 100. Note that the first module controller 520 only operates when the energy storage is at a high enough potential.

The circuit board 500 monitors the voltage of every individual cell 100. The circuit board 500 may also monitor the temperature of selected cells 100, such as every other energy storage cell 110. Voltage and temperature measurements are reported to the module controller 130. The module controller 130, in turn, communicates commands and data with cabinet controller 610 via Ethernet, and receives power via Power over Ethernet (POE) from the POE PSE switch 940. A DC to DC converter associated with the module controller 520 is powered by syphoning power from the energy storage cells 110 being managed.

It is observed from the arrangement in FIGS. 1 through 3 that the module 100 does not include a housing. However, it is within the scope of this disclosure for a housing to be provided between the bulkheads 142, 144 in order to hold and to secure the plurality of energy storage cells 100 and the cooling tubes 120. In one aspect, the housing comprises an elongated sleeve having a contoured interior configured to enclose and contact each of the cooling tubes 120. The housing may include a mount configured to retain a circuit board to the elongated sleeve housing as well. An arrangement of a housing sleeve securing energy storage cells and a small controller is shown and described in connection with the '868 patent cited above and need not be shown or described further herein.

It is also observed that the module 100 as shown in FIGS. 1 through 3 is configured to be stackable. In this respect, five to twenty modules 100 may be stacked one on top of the other. Preferably, individual modules 100 are placed on rails or trays within a large cabinet, in a vertical arrangement. In this way, an energy storage assembly may be formed wherein a plurality of vertically-arranged energy storage modules 100 are electrically connected to each other in series via busbars 118.

Providing a plurality of ultra-capacitors, such as ultra-capacitor cells 110, in series allows an operator to pre-select a desired number of energy storage modules 100. This, in turn, allows for an assembly to have a predetermined operational value, including a predetermined voltage and/or capacitance. In addition, the lengths of energy storage modules 100 can be altered to provide discrete operational values for each device, and thus a different cumulative value for the assembly as a whole.

In one aspect, multiple cabinets may be placed in side-by-side arrangements. Each cabinet with its corresponding energy storage devices may be referred to as an energy storage assembly. Each energy storage assembly 400, in turn, is in electrical connection with an adjacent energy storage assembly 400.

FIG. 4 is a perspective view of an energy storage assembly 400 of the present invention, in one embodiment. The energy storage assembly 400 comprises a plurality of individual energy storage modules 100, arranged in vertical stacks.

The energy storage assembly 400 first comprises at least one cabinet 410. It can be seen that in the arrangement of FIG. 4, two cabinets 410 are provided in adjacent relation. This shows that the assembly 400 is scalable. In this respect, numerous cabinets 410, each containing stacks of energy modules 100, may be provided and connected to a micro-grid.

Each of the illustrative cabinets 410 includes upper frame members 412, lower frame members 414, front frame members 416, and rear frame members 418. Each cabinet 400 is supported by feet 420, which may be in the form of rubber pads, casters, or other support members. In one aspect, the feet 420 are fabricated from ceramic to provide electrical insulation.

In one aspect, the feet 420 comprise a hardened polymeric material. The polymeric feet 420 have a serrated profile, allowing the feet 420 to absorb vibratory forces along the ground such as may be caused by a nearby motor or even a seismic event.

Each cabinet 400 further includes an upper support base 432 and a lower support base 434. The support bases 432, 434 provide lateral support for the frame members 412, 414, 416, 418. The support bases 432, 434 also provide gravitational support for equipment on the cabinets 400.

Of importance, each cabinet 410 includes racks 430, which may be in the form of rails. The racks 430 are in pairs, with each pair of racks 430 supporting a respective energy storage module 100. In the arrangement of FIG. 4, each cabinet 410 is configured to slidably hold 10 energy storage modules 100, meaning 10 sets of racks 430 are provided. Thus, the pair of cabinets 410 and their respective racks 430 hold a total of 20 modules 100.

Each module 100 can be slidably pulled or removed from its cabinet 410. In this way, maintenance can be conducted on components of the module 100, such as the replacement of any energy storage cell 110 that has shorted or burned out or replacing the module controller 130. In one aspect, each cabinet 410 is 8.2 feet (2.5 meters) in height, while each rack 430 is about 3.3 feet (1 meter) deep. Each module 100 may be about 2 feet (600 millimeters) wide.

It can be seen that busbars 118 connect not only terminals 112, 114 within an individual energy storage module 100, but also across adjacent energy storage modules 100. Stated another way, the busbars 118 provide electrical coupling between not only rows of energy storage modules 100, but also adjacent energy modules 100. The busbars 118 are connected to alternating positive 112 and negative 114 terminals. In this way, all energy storage modules 100 are placed in series.

The cabinets 410 are also designed to be portable. In the arrangement of FIG. 4, the two cabinets 410 are secured together, with each cabinet having a fork lift sleeve 422. Each sleeve 422 includes an opening 425 for receiving a fork lift tine, thus serving as a lift point.

The energy storage assembly 400 includes an optional Auxiliary Power Source (APS). This is shown schematically at 460. The APS 460 may contain, for example, a rechargeable battery pack or so-called electrical generator.

The energy storage assembly 400 also includes a pair of bypass switches 440. Each bypass switch 440 is supported by the upper support base 432. The bypass switches 440 are configured to bypass energy storage when a fault occurs.

FIG. 6 is a circuit diagram 600 that shows the general electrical connections between the energy storage modules 100. More specifically, FIG. 6 shows how all ultra-capacitor cells 100 are connected together within the cabinets 410.

Modules 1 through 10 are indicative of the energy storage modules 100 stored in a first cabinet 410. Similarly, Modules 11 through 20 are indicative of the energy storage modules 100 stored in a second cabinet 410. Modules 1 through 10 are connected with one another in series; likewise, Modules 11 through 20 are connected with one another in series. Of interest, Modules 1 through 10 are also connected with Modules 11 through 20 in series. Current flows from Module 1 to Module 10, and then into adjacent Module 11. Current then flows from Module 11 to Module 20, and then onto yet another adjacent module in another cabinet 410 (not shown).

In one aspect, a negative terminal of Module 10 may be connected to a positive terminal of Module 11. At the same time, the negative terminal of Module 10 and the positive terminal of Module 11 may both be tied to the chassis. This allows a cabinet 400 to, for example, provide 960 cells (480 cells in Modules 1 through 10 and 480 cells in Modules 11 through 20) in series with each other without exceeding 1,500 volts between any two components in a cabinet 410. Those of ordinary skill in the art will understand that 1,500 volts is sometimes considered to be a threshold for a low-voltage system.

A cabinet controller 610 is provided with the circuit 600. The cabinet controller 610 operates switches 612, 614. The switches 612, 614, in turn, control the amount of energy stored in the Modules by activating discharge resistors 621, 623. Data is fed from the module controllers 130 to the cabinet controller 610. The cabinet controller 610 is capable of activating bypass switches 440 for any stack of modules 100 to turn off, or bypass, current. In this way, operation of an energy storage assembly comprising a pair of cabinets 410 can continue even if any modules 100 in an individual cabinet 410 experiences a problem or fault.

To facilitate a bypass of current, electro-mechanical switches 622, 624 are employed. The electro-mechanical switches 622, 624 may be in the form of, for example, a magnetic low-voltage switch (“MLV”), an electro-mechanical relay, or a silicon controlled rectifier (“SCR”). In FIG. 6, the switches 622, 624 are shown below the stacked modules 100.

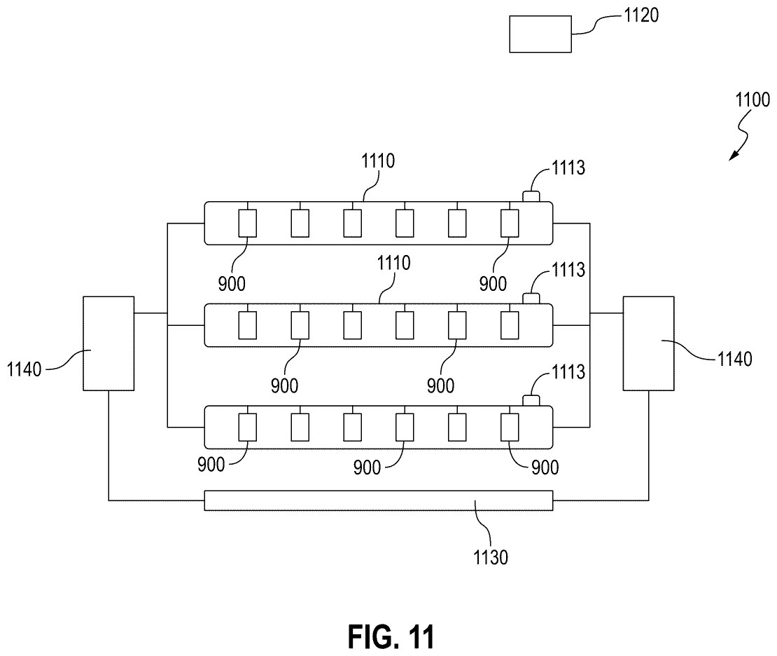

The modules 100 and their cabinets 410 are designed to be placed in electrical connection with a power grid. The power grid may be, for example, a privately owned power station, a dedicated industrial power station, a power station managed by a utility company, or a municipal power exchange. Note that the energy storage assembly 400 may include a high frequency current transformer (shown schematically at 1130 in FIG. 11).

Returning back to FIG. 4, the energy storage assembly 400 finally includes a cooling system. A portion of the cooling system is seen in FIG. 4. Specifically, air coolant ducts 450 are observed.

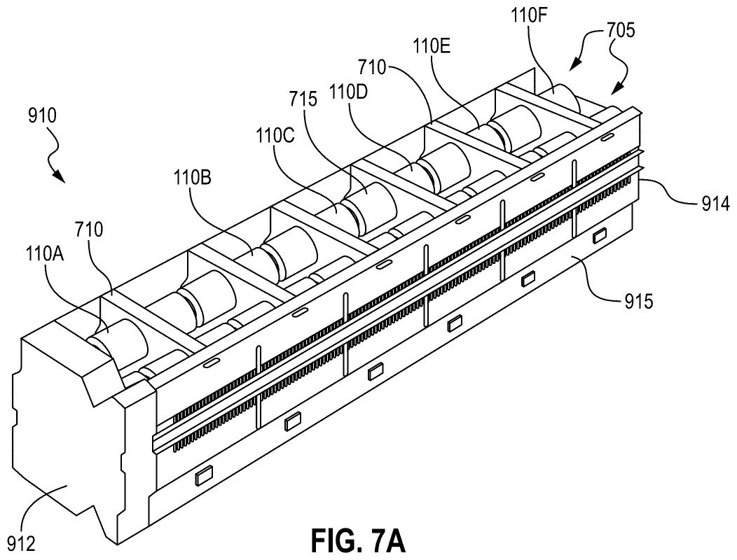

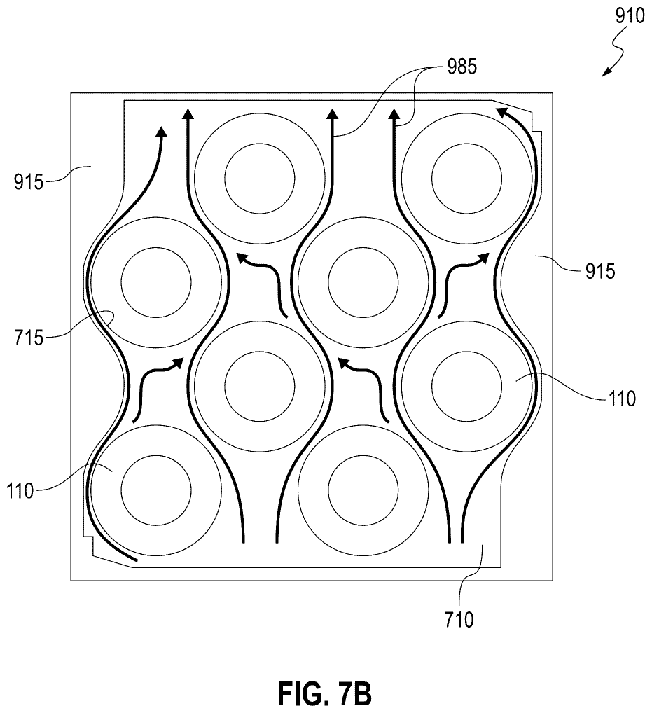

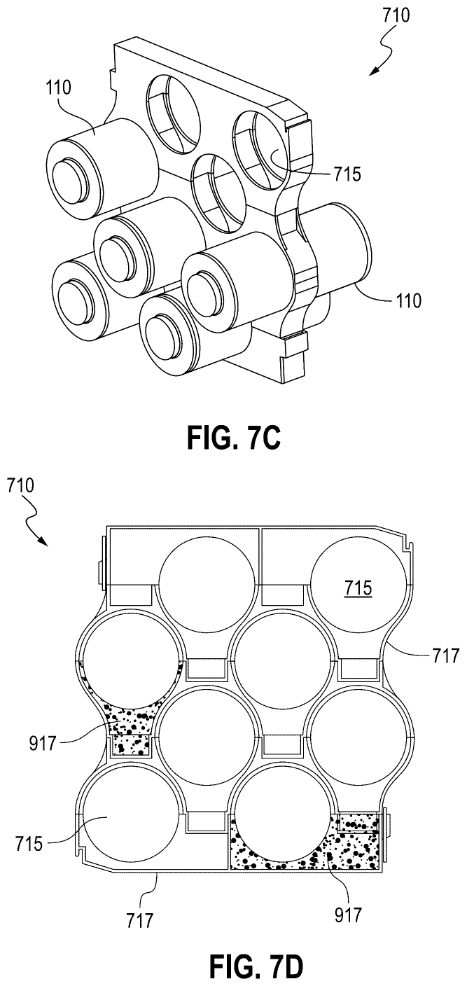

FIG. 7A is a perspective view of an energy storage module 910 of the present invention, in an alternative embodiment. In this arrangement, the energy storage module 910 comprises an elongated rectangular housing 915. The housing 915 has a front end 912 and a back end 914. The housing 915 is fabricated from a non-conductive material such as a hardened polymeric material. Ideally, the housing 915 is designed to provide support during a major seismic event.

The energy storage module 910 may be 200 to 250 mm wide, 210 to 230 mm in height, and 910 to 950 mm in length. In one aspect, the module 910 mass is approximately 30 kg.

The housing 915 of the energy storage module 910 holds multiple row 705 of ultra-capacitor cells 110. Six ultra-capacitor cells 110 may reside along each row 705. These are represented as cells 110A, 110B, 110E, 110F. The ultra-capacitor cells 110 reside electrically in series, and may optionally be welded end-to-end for lateral support.

The ultra-capacitor cells 110 are supported along the housing 915 by bulkheads 710. The bulkheads 710 are spaced equi-distantly apart along the housing 915. The bulkheads 710 have through-openings (shown in FIG. 7B at 715) dimensioned to closely and slidably receive the energy storage cells 110. The bulkheads 710 may be configured to receive two rows of energy storage cells 110 along a same horizontal plane, as is done in energy storage module 110 described above. However, it is preferred to employ through-openings 715 that support eight rows 705 of energy storage cells 110 along staggered vertical planes. In one aspect, the module 910 contains 48 cells in series. These represent 6 energy storage cells 110 placed along 8 rows 705.

FIG. 7B is a cross-sectional view of the energy storage module 910 showing 8 rows of energy storage cells 110, spaced apart within the housing 915. Specifically, adjacent rows are offset so that they are not co-planar. This facilitates the flow of air (indicated by Arrows 985) through the housing 915 and around the energy storage cells 110.

In one embodiment, 48 ultra-capacitor cells each provide 3,000 F. Each cell has a maximum voltage of 3V, giving the module 910 a total maximum voltage of 144V, while the nominal voltage is 2.4V per cell. This produces a total nominal voltage of 115.2V. This configuration supports a maximum voltage (VMax) of 144V, ensuring sufficient headroom for safe operation during significant grid events. Voltages may be measured using resistor dividers referenced to ground and buffered with an Op Amp to prevent inaccuracies.

FIG. 7C is a perspective view of one of the bulkheads 710 of FIG. 7A. In this view, 8 through-openings 715 are shown. The through-openings 715 are sized to closely receive a corresponding energy storage cell 110. In the view of FIG. 7C, five energy storage cells 110 have been placed through respective through-openings 715, leaving three apertures 715 open for illustrative purposes.

It is observed that the energy storage cells 110 are spaced apart. The spacing of the through-openings 715 in the bulkheads 710 is optimized to space the cells 110 apart from each to achieve balance between air path spacing and overall footprint. In one embodiment, air is given 6 to 8 mm between energy storage cells 110 to pass through. Forced air cooling can be provided by either fans residing on the energy storage assembly 900 that help move air between the cells 110 and rapidly exit the cabinet 950, or from an externally driven blower through a ducting system 450.

FIG. 7D is a front plan view of the bulkhead 710 of FIG. 7C. Here, the energy storage cells 110 have been removed. Thus, 8 separate through-openings 715 are visible. Below each through-opening 715, the bulkhead 710 is hollow, providing eight separate reservoirs 717. The reservoirs 717 are designed to capture electrolytic fluids that may escape (or vent) from the ultra-capacitors 110. In FIG. 7D, electrolytic fluid is shown at 917 below two of the through-openings 715.

Those of ordinary skill in the art will understand that when an energy storage cell vents, it primarily releases liquid electrolyte as a pressurized spray. As the pressure is relieved, the energy storage cell transitions to drips of electrolyte exiting the cell. The liquid electrolyte contains dissolved and suspended materials that are carried with the electrolyte. Liquid electrolyte typically evaporates quickly, and the vapors would be carried out of the cabinet 950 by the cooling system, that is, the flow of forced air. However, the dissolved and suspended materials will not evaporate, but form as a residue wherever liquid electrolyte was present.

This residue typically contains ionic salts making it slightly conductive. If placed between nodes at different potentials, an unintended electrical path could be formed. To ensure no electrical path can be developed between nodes, the bulkheads 710 are designed to include the electrolyte capture reservoir 717.

It can also be seen in the arrangement of FIG. 7D that adjacent columns of energy storage cells 110 are offset from one another. Stated another way, cells 110 in adjacent rows are not along the same horizontal plane. Staggering the energy storage cells 110 in this way encourages turbulent flow and mixing of air.

In another aspect of an energy storage assembly 400, a plurality of energy storage modules 100 may themselves be placed in side-by-side relation, forming an assembly of horizontally-placed modules. These horizontally placed modules may then, optionally, be stacked to form a larger energy storage assembly. In any event, it can be seen that the assembly 400 is scalable to meet operational demand.

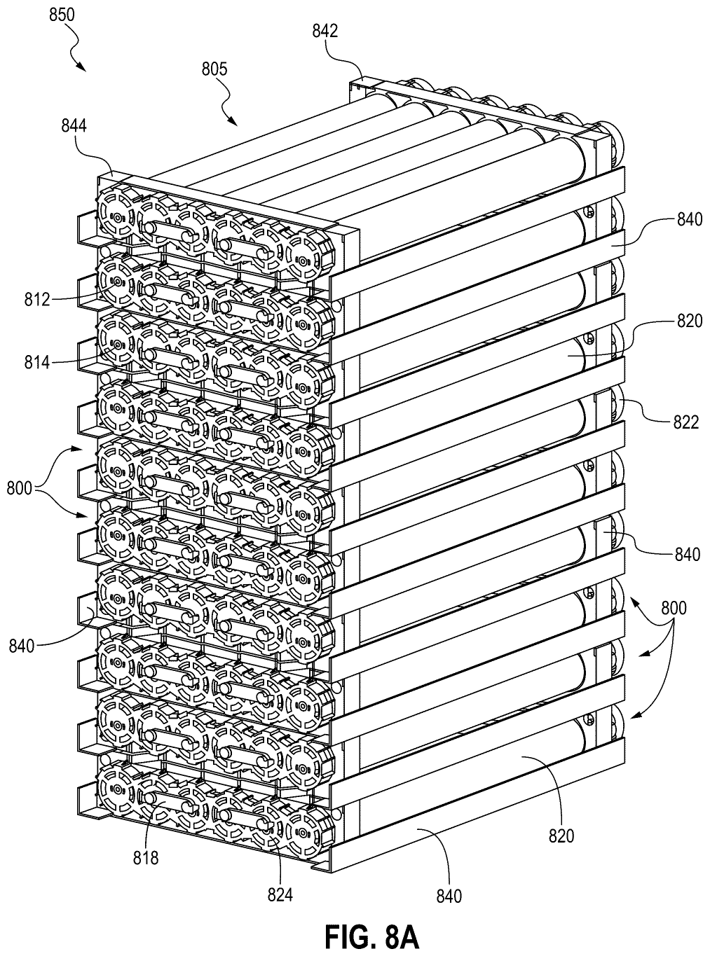

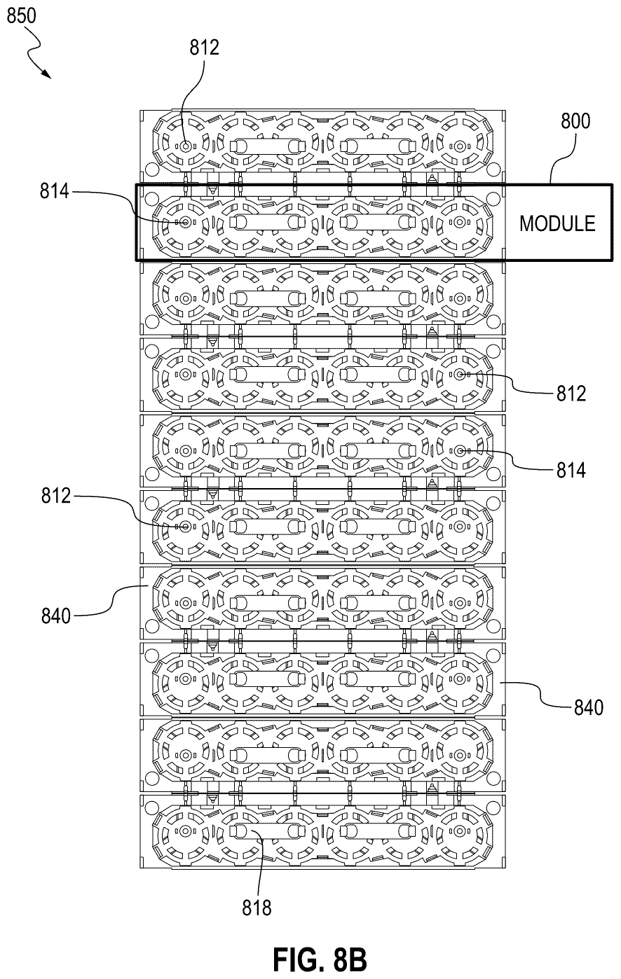

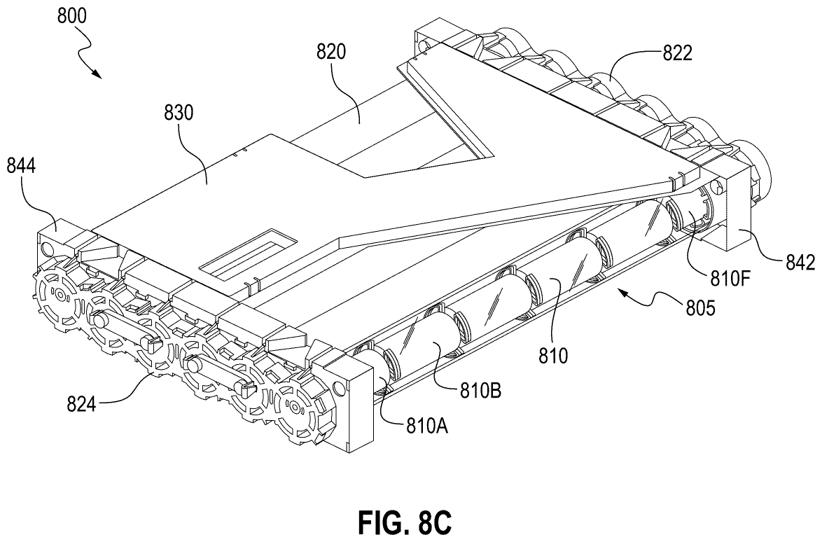

FIG. 8A is a perspective view of a plurality (or stack) 850 of energy storage modules 800, placed one on top of the other, in an alternate embodiment. The stack 850 represents a portion of an energy storage assembly. Each energy storage module 800 comprises an array of ultra-capacitors 810.

FIG. 8B is an end view of the stack 850 of energy storage modules 800 of FIG. 8A. As shown, the stack 850 represents ten energy storage modules 800 stacked one on top of the other.

FIG. 8C is a perspective view of one of the energy storage modules 800 of FIG. 8B. In this view, one of the cooling tubes 820 has been removed, revealing individual ultra-capacitor cells 810A, 810B, . . . 810F.

The energy storage modules 800 will be described with reference to FIGS. 8A, 8B, and 8C, together.

Each energy storage module 800 is supported by a pair of bulkheads, or end plates. These are indicated as a first bulkhead 842 and a second bulkhead 844. The bulkheads 842, 844 comprise a plurality of equi-distantly spaced through-openings (not visible, but see apertures 145 in FIGS. 1 and 3). The through-openings are dimensioned to closely receive tubular coolant tubes 820.

As with the energy storage modules 100, each of the energy storage modules 800 holds rows 805 of energy storage cells 810. In the illustrative arrangement, 6 energy storage cells 810A, 810B, . . . 810F are placed in series. At the same time, 6 rows of energy storage cells 810 are provided in side-by-side relation. Thus, a six-by-six array of cells 810 is presented. With ten energy storage modules 800 stacked one on top of the other, a total of 360 energy storage cells 810A-810F are provided.

The rows 805 of energy storage cells 810 have alternating positive (or input) 812 and negative (or output) 814 terminals. Electrical energy is transmitted from the positive terminal 812, into energy storage cell 810A of each row 805, on to energy storage cell 810F of each row 805, and to negative terminal 814. All energy storage cells 810 are connected and arranged in series, meaning that the negative terminal 814 of one row 805 is in electrical communication with the positive terminal 812 of an adjacent row 805.

In the arrangement of FIGS. 8A, 8B, and 8C, the opposing ends of the rows 805 of ultra-capacitor cells 810A-810F are covered by an end cap. End caps 822 reside outside of bulkhead 842, while end caps 824 reside outside of bulkhead 844. The end caps 822, 824 are fabricated from a non-conductive polymeric material. Of interest, each end cap comprises six small through-openings that accommodate terminals. Thus, the openings in the bulkheads 822, 824 accommodate terminals 812, 814.

The terminals 812, 814 are connected by conductive busbars (seen at 118 in FIGS. 1 and 3). Specifically, the busbars 118 will connect the adjacent negative 814 and positive 812 terminals. The busbars 118 may reside either inside of or outside of the respective end caps 822, 824, so long as the busbars 118 are in physical connection with the appropriate terminals 812 and 814.

The busbars 118 are not visible in FIG. 8A, 8B, or 8C as they are covered by specially-configured busbar covers 818. The busbar covers 818 prevent accidental contact with electrical connections. Holes in the end caps 822, 824 are configured to minimize possibility of accidental contact with electrical connections inside the cooling tubes 820.

The end caps 822, 824 provide axial restraint to the energy storage cells 810A-810F. Each end cap 822, 824 comprises holes that allow cooling air to pass through the associated tubes 820. One of the end caps 822 or 824 interfaces with a coolant duct, such as coolant duct 450, as described above.

Each module 800 is supported by shelving, or rails 840. The rails 840 support the bulkheads 842, 844, which in turn support the cooling tubes 820. Stated another way, the bulkheads 842, 844 provide side-to-side support for the module 800.

As seen in FIG. 8C, a plurality of ultra-capacitors 810A, 810B, . . . 810F reside within the cooling tubes 820. Preferably, ultra-capacitors 810A, 810B, . . . 810F along a row 805 are oriented in an end-to-end configuration. The energy storage cells 810 may be welded together end-to-end. Optionally, the spacers 125 of FIG. 3 may be used to centralize the energy storage cells 810 within the cooling tubes 820. Alternatively, an inner diameter of each cooling tube 820 may be manufactured with integral fins that centralize the cooling tubes 820. Both embodiments facilitate the flow of a cooling working fluid. Positive 812 and negative 814 terminals reside at opposite ends of the energy storage cells 810.

Finally, the energy storage module 801 comprises a module controller 830. The controller 830 monitors the rows 805 of energy storage cells 810. Preferably, the controller 830 is configured to provide cell balancing within rows 805. The controller 830 may also monitor conditions within or along each module 800 such as temperature.

FIG. 9A is a perspective view of an energy storage assembly 900 of the present invention, in an alternative embodiment. As can be seen, the energy storage assembly 900 defines a cabinet 950 which houses a plurality of individual energy storage modules 910.

The cabinet 950 comprises a frame 955. The frame 955 includes a bottom support 952 (or bottom frame member), and a top support 954 (or top frame member). Intermediate the bottom 952 and top 954 supports is a pair of side walls 956. In the view of FIG. 9A, only one side wall 956 is visible. However, it is understood that another side wall 956 resides between the bottom 952 and top 954 frame members opposite the wall 956 that is shown.

Preferably, the side walls 956 are fabricated from a metallic material. This creates a so-called Faraday cage around the modules 910. The Faraday cage attenuates radiated emission of electric signals generated as a result of changing magnetic fields.

In one arrangement, the frame 955 is 500 to 600 mm wide, 900 to 1,200 mm in depth, and 3,000 to 3,300 mm in height. The entire assembly 900 mass may be up to 2,000 kg. The frame construction allows for a smaller footprint and increased energy storage density. It also affords easy maintenance, as well as resilience during seismic events. At the base of the frame, forklift sleeves (such as sleeves 422 of FIG. 4) may be integrated into the frame design for transport.

Immediately below the bottom support 952 are a plurality of feet 960. The feet 960 support the cabinet 950 above a ground surface. In one embodiment, the feet 960 space the cabinet 950 above the floor by 500 mm to 600 mm. The feet 960 are fabricated from a non-conductive material. In one aspect, the feet 960 comprise a hardened polymeric material. The polymeric feet 960 have a serrated profile, allowing the feet 960 to absorb vibratory forces along the ground such as may be caused by a nearby motor or even a seismic event.

The cabinet 950 also comprises a plurality of vertical frame members 958. The vertical frame members 958 reside between the bottom 952 and top 954 frame members. The vertical frame members 958 may be used to secure the side walls 956. As will be discussed further below, the vertical frame members 958 and connected side walls 956 help direct air up through the cabinet 950.

Above the top frame 954 is a fan housing 980. The fan housing 980 comprises an air circulation device. The air circulation device may be a conventional fan 982 having a motor and a plurality of blades. Alternatively, the air circulation device may be a so-called bladeless fan wherein air is moved through the Coanda effect to create airflow. In either instance, air is pulled up through the cabinet 950 and out of the fan housing 980. As air is pulled from the cabinet 950, it moves through the energy storage modules 910 and across the ultra-capacitors 110.

In one aspect, the fan housing 980 may include a filter medium 957. The filter medium 957 may comprise a HEPA filter, and is designed to filter particles as air is circulated vertically into our out of the cabinet 950.

The cabinet 950 also includes a door 970. The door 970 pivots about a plurality of hinges 972 positioned along one of the vertical frame members 958. An inner face of the door 970 holds a controller 610 along with other electrical components. Such components may include back-up batteries (or other back-up energy storage cells) 945. The back-up batteries 945 are part of an Auxiliary Power System (“APS”).

In the arrangement of FIG. 9B, two APS' are provided. Each APS is capable of powering the entire cabinet 950 for several minutes to hours via an uninterruptable power supply, e.g., chargeable battery packs 945. This means that a disruption in the grid will not immediately bring down power to the energy storage assembly 900.

During operation, the onboard APS syphons power from the energy storage modules 910. The syphoned power is used to power the controller 610 as well as the cooling system, that is, fan 982, as well as recharge battery packs 945 to continue to supply auxiliary power in the event of a power outage or shutdown. The APS resides in auxiliary power system trays 946, and includes the chargeable battery packs 945.

The energy storage assembly 900 may be referred to as a modular ultra-capacitor stored energy system. This is because the energy storage assembly 900 includes a plurality of energy storage modules 910. The modules 910 are designed to hold energy storage cells, such as ultra-capacitor cells 110, in series.

In the arrangement of FIGS. 9A and 9B, the energy storage modules 910 are arranged vertically on shelves, or rails 930. Forty rails 930 are provided, with two rails 930 holding one module 910. Thus, a 2×10 array of modules 910 is offered. The modules 910 are connected to each other via bolted bus bar connections (such as by using the busbars shown at 118 in FIG. 1). The busbars are placed on the front 912 of each module 910.

In one aspect, rows 705 of energy storage cells 110 are welded together at the back of the module 910 via a busbar 118. The energy storage cells 110 then have a bolted connection at the front 912 of the module 910. This allows the 48 cells to be connected by 48 welded connections and 8 bolted connections.

It can be seen in FIG. 9A that one module 910 has been partially removed, or pulled, from a rails 930 for illustrative purposes. Individual modules 910 may be removed for maintenance without taking the entire storage assembly 900 offline.

A module circuit board (such as shown at 500 in FIG. 5) is employed. The circuit board includes a module controller (such as shown at 130 in FIGS. 1 and 5). The module controller 130 provides monitoring and cell voltage balancing for the ultra-capacitor cells 110. The nominal target for cell balancing is ±10 mV between cells (and less than 20 mV between the lowest and highest voltage).

The module controller 130 reports to the cabinet controller 610 along the door 970. An integrated wiring harness connects each energy storage cell 110 to the circuit board 500 for voltage and temperature monitoring. Due to voltage deviations that will result from normal operating conditions, the cabinet controller 610 is programmed to measure and compare the voltages across each cabinet 950, and activate balancing resistors in any cabinet 950 where a voltage is over target.

In most conditions, balancing resistors are more than sufficient to balance energy storage cells 110 within a cabinet 950. During edge-case circumstances, the discharge resistors 1000 associated with a cabinet 950 can be activated to reduce the voltage to within a target range.

Voltage and temperature monitoring is conducted by the module controller 130. Cell failures can be predicted before they happen by actively managing cell voltage. By balancing cell voltage, the degradation rate of the energy storage cells 110 is kept consistent between cells, and the overall degradation rate of the whole assembly 900 is reduced. In one aspect, a module 910 may be marked for replacement when the first energy storage cell 110 reaches end of life, even if other energy storage cells 110 in the module 910 have not reached end of life.

FIG. 9B provides a front view of the energy storage assembly 900 of FIG. 9A. In this view, the door 970 is in its open position. The cabinet controller 610 is visible. The cabinet controller 610 is held within a control tray 942. Optionally, a separate controller 947 may reside along the door 970 in a separate control tray 942. Together, the controllers 610 and 947 control and monitor the state of health of the modules 910 and fault conditions.

It is recognized that some random hardware failures in electronics are unavoidable. Thus, the cabinet controller 610 is also programmed to identify potential problems in control and monitoring circuits, and to take appropriate action to keep the modules 910 safe and meeting power and uptime requirements. To this end, the cabinet controller 610 is able to identify modules 910 that are experiencing random hardware failures, and bypass them.

In one aspect, the cabinet 950 is divided into four “quadrants” of five modules 910 each. Any quadrant can be bypassed as needed to maintain system safety. Beneficially, each energy storage assembly 900 may be sized with redundant modules 910 to allow full power coverage with a few quadrants bypassed. Circumstances which may call for bypass include random hardware failure events and to prevent the venting of an ultra-capacitor cell 110.

In operation with ultra-capacitor cells 110, if a bypass triggering event occurs, a discharge transistor is activated to dissipate power from the quadrant to be bypassed. Once the quadrant is mostly discharged, a solid-state switch is activated to directly short the quadrant, completely discharging the quadrant. Once the quadrant is fully discharged, an electro-mechanical switch 622, 624 is transitioned to a closed state, which holds the quadrant in bypass. The electro-mechanical switch 622, 624 may be bi-stable (latching). While bypassed, the ultra-capacitor cells 110 are unable to accumulate any charge, including from voltage rebound. The quadrant remains in a bypassed state until a positive control signal is given to the bypass switch to open. Even if a cabinet controller 610 in an energy storage assembly 900 were to lose power, the bypassed quadrant will remain safely in bypass position.

During maintenance, a module 910 can be quickly removed from its rails 930 by disconnecting two bolted busbar connections 118, one ethernet communications connection, and an optional locking mechanism that holds the module 910 in place. The module 910 is pulled out as shown in FIG. 9A, and a replacement is inserted.

Also visible in FIGS. 9A, 9B are the feet 960. The feet 960 may be referred to as isolator posts. This is because the feet 960 electrically isolate the cabinet 950 and its internal components from the ground or floor surface.

Above the feet 960 is the bottom frame 952. The bottom frame 952 may comprise a so-called partial discharge pan 953. The partial discharge pan 953 is generally flat across the bottom, but curves up with a minimum bend radius of not less than 30 mm. The large bend radius spreads out the electric field along the bottom frame 952, reducing the concentration of electrons and preventing (or at least reducing) a partial discharge path for electric charge.

Those of ordinary skill in the art will understand that partial discharge is the unintended leakage of electrons between conductors at different voltages. This leakage can be prevented by reducing the intensity of the electromagnetic field which may otherwise concentrate on corners, and edges. By making smooth, large radius bends, the electromagnetic field can be dispersed, reducing field intensity. In one arrangement, the partial discharge pan 953 is a smooth piece of formed sheet metal that defines the shape of the electromagnetic field between the bottom frame 952 and the floor.

Above the bottom frame 952 and within the cabinet 950 are the plurality of energy storage modules 910. In the arrangement of FIG. 9B, the right side of the modules 910 have been removed for illustrative purposes. This demonstrates a flow path for cooling air through the cabinet 950. Arrow 985 shows air being pulled up through the fan housing 980.

The fan 982 and its air circulation components are designed to keep the ultra-capacitor cells 110, the controller 970, and other electrical equipment at a cool temperature. Maintaining a cool temperature is important for extending cell lifetime performance. By allowing air to efficiently flow between the ultra-capacitor cells 110, a lower temperature can be sustained.

It is understood that the fan housing 980 could alternatively be positioned under the cabinet 950 and under the bottom frame 952. In that instance, air is pushed upward through the modules 910 and across the ultra-capacitors 110. Alternatively, the cabinet 950 may be connected to an external air supply.

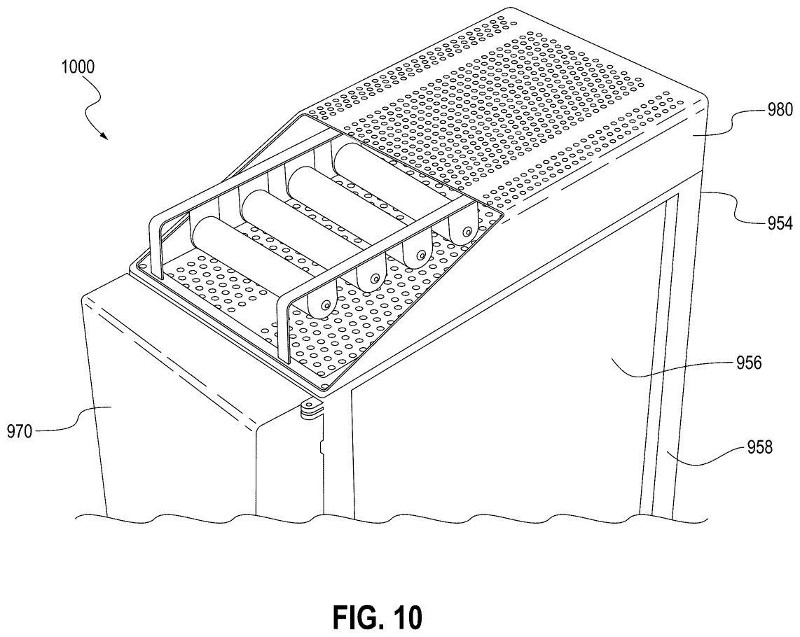

Finally, FIG. 10 is a cut-away view of the fan housing 980. In this view, a series of discharge resistors 1000 is visible. The discharge resistors 1000 allows the cabinet 950 to dissipate stored energy in various circumstances. For example, the discharge resistors 1000 convert stored energy within the modules 910 to heat. The discharge resistors 1000 are expected to get hot during full discharge events. For this reason, the resistors 1000 may be positioned at the upper end of the cabinet 950. The discharge resistors 1000 can then benefit from the cooling air which passes through the cabinet 950 and the modules 910.

As can be seen, unique energy storage assemblies 400, 900 are provided herein. Each energy storage assembly 400, 900 serves as a self-contained island for storing electrical energy. Each energy storage assembly 400, 900 offers a versatile and efficient solution for high-power applications. In one aspect, the assemblies 400 or 900 may integrate with and support a flexible AC transmission system, or so-called FACTS system. One example of a FACTS system is the AC transmission system developed by GE Vernova headquartered in Cambridge, Massachusetts.

The energy storage assembly 400 or 900 may be used to either source or to sink active power in a FACTS system. Voltage Source Converters (shown as an MMC at 1130 in FIG. 11) are connected to the energy storage assembly 900. The MMC's 1130 convert power between AC and HVDC. The MMC's 1130 can readily access energy from the energy storage assembly 900.

FIG. 11 is a schematic view of an energy storage system 1100 of the present invention, in one embodiment. The energy storage system 1100 utilizes a series of energy storage assemblies 900 residing in series. Sets of energy storage assemblies 900 form strings 1110. In the view of FIG. 11, three strings 1110 are shown, with each string 1110 having six energy storage assemblies 900. Of course, this is merely illustrative as additional strings 1110 having fewer or greater energy storage assemblies 900 may be deployed.

Each string 1110 will have its own string controller 1113. The string controllers 1113 gather data, and report up to a central system controller 1120. Stated another way, the string controllers 1113 handle string level monitoring, control, and fault detection. The central system controller 1120 is programmed to provide data to a Human Machine Interface.

Optionally, each string 1110 has two string controllers, representing a primary controller 1113 and a redundant, or spare, controller (not shown). Each string controller 1113 is connected to each energy storage assembly 900 for which it is responsible via a fiber optic cable.

Within a string 1110, each energy storage assembly 900 provides physical structure through the cabinets 950. In addition, each energy storage assembly 900 provides electrical isolation, cooling, EMI protection, and features to mitigate partial discharge.

The collection of strings 1110 may be referred to as a hall. The strings 1110 of energy storage assemblies 900, or hall, are connected to Medium Voltage Direct Current (“MVDC”) equipment. MVDC equipment refers to the electrical components used in systems that transmit power at medium voltage levels using direct current (DC) instead of alternating current (AC). Such equipment may include circuit breakers, switchgear, and other infrastructure for DC grids. In general, MVDC is a technology used for efficient and reliable energy transmission and distribution. The technology is particularly useful in applications like integrating renewable energy sources and supporting modern, decentralized power networks.

The MVDC equipment is connected to a converter, such as a Modular Multilevel Converter (“MMC”) 1130. An MMC is a fast-processing device that regulates voltage and provides reactive power compensation in power grids. The opposing MVDC equipment 1140 represents Plus and Minus terminals for a DC-Link to the STATCOM MMC 1130. Thus, in FIG. 11, the energy storage strings 1110 are connected between the Plus and Minus terminals of the MVDC 1140 equipment.

Of interest, each connection between cabinets 950 includes an electromagnetic coupling device. The device is intended to absorb transient conducted electrical emissions. In one aspect, the electromagnetic coupling device comprises a resistor-capacitor array designed to absorb and safely dissipate conducted emissions between the electrical connection between cabinets 950, and the frame 958 of the cabinet 950.

The power requirement of a string 1110 defines the voltage distributed across the energy storage assemblies 900 along the entire string 1110. The number of strings 1110 and cabinets (energy storage assemblies 900) can be adjusted to scale the system 1100 as needed for varying capacities.

The energy storage system 1100 is designed to provide the STATCOM 1130 with additional power (either for source or for sink) as needed by the STATCOM 1130 to continuously stabilize the grid. The energy storage system 1100 is further designed to be flexible and can be sized to provide whatever continuous power requirement a Transmission System Operator may specify. The energy storage system 1100 may spend most of its time in an operational state, cycling small amounts of power (relative to max power capability) in and out of the grid, via the STATCOM 1130. If a grid has too much power, the energy storage assembly 900 can absorb the power. On the other hand, if the grid needs power, then energy stored in the energy storage assembly 900 can provide the power.

In the claims which follow, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

We claim:

1. An energy storage assembly for storing electrical energy, the energy storage assembly comprising:
a cabinet;
a first energy storage module residing within the cabinet and having a positive terminal for receiving and delivering electrical energy;
a second energy storage module residing within the cabinet and having a negative terminal for receiving and delivering electrical energy;
a plurality of intermediate energy storage modules residing between the first and the second energy storage modules, wherein each of the first, the second, and the intermediate energy storage module comprises:
two or more rows of energy storage cells, with the energy storage cells being connected electrically in series, and wherein each row of energy storage cells has its own positive terminal and negative terminal;
at least two bulkheads having through-openings, wherein each through-opening receives a respective energy storage cell to support a row of the energy storage cells; and
a cooling system connected to the cabinet and configured to force air from a first end of the cabinet to a second end of the cabinet;
and wherein:
the rows of energy storage cells within each energy storage module reside electrically in series;
forcing air from a first end of the cabinet to the second end of the cabinet causes air to flow across the energy storage cells; and
the energy storage modules reside electrically in series between the positive terminal of the energy storage assembly and the negative terminal of the energy storage assembly.

2. The energy storage assembly of claim 1, wherein the energy storage cells comprise batteries, capacitors, or a combination thereof.

3. The energy storage assembly of claim 2, further comprising:
a plurality of busbars, wherein:
each of a first portion of the busbars connects the negative terminal of a first energy storage module with the positive terminal of an adjacent second energy storage module; and
each of a second portion of the busbars connects the negative terminal of a first row of energy storage cells to the positive terminal of an adjacent second row of energy storage cells.

4. The energy storage assembly of claim 3, wherein:
the plurality of intermediate energy storage modules comprises at least two energy storage modules.

5. The energy storage assembly of claim 4, wherein:
each of the energy storage modules resides on a rack, a shelf or a rail within the cabinet; and
the energy storage modules are stacked in vertical arrangement along the cabinet.

6. The energy storage assembly of claim 4, wherein:
the negative terminal of each row of energy storage cells is in electrical connection with a positive terminal of an adjacent row of energy storage cells such that the rows of energy storage cells are in series.

7. The energy storage assembly of claim 6, wherein:
each row of energy storage cells comprises at least two energy storage cells positioned end-to-end; and
adjacent rows of energy storage cells are staggered so as not to be positioned along the same vertical plane.

8. The energy storage assembly of claim 6, further comprising:
at least one temperature sensor associated with each energy storage module;
a bypass switch associated with one or more energy storage modules; and
a module controller associated with each energy storage module, wherein each module controller is configured to (i) receive data related to voltage across each energy storage module, and (ii) generate bypass instructions for a bypass switch associated with the respective energy storage module in its respective cabinet.

9. The energy storage assembly of claim 8, further comprising:
a cabinet controller configured to (i) receive data from each of the module controllers and, in response, control the bypass switches associated with the energy storage modules.

10. The energy storage assembly of claim 9, wherein the cooling system comprises a plurality of fans or a port for externally supplied forced air.

11. The energy storage assembly of claim 10, wherein:
the first end of the cabinet is opposite the second end of the cabinet; and
the plurality of fans or the port reside at the first end of the cabinet.

12. The energy storage assembly of claim 2, wherein each bulkhead comprises a reservoir residing below one or more of the through-openings configured to receive fluid that may escape from one or more of the energy storage cells.

13. The energy storage assembly of claim 2, wherein the cabinet is in electrical communication with a power station, a power sub-station, a micro-grid, or power conditioning equipment.

14. The energy storage assembly of claim 2, wherein the cabinet comprises:
a first side wall;
a second side wall opposite the first side wall;
a door;
a third side wall opposite the door;
a top surface; and
a bottom surface;
wherein all side walls, surfaces, and the door are fabricated from a metal material, thereby forming a Faraday cage for the cabinet.

15. The energy storage assembly of claim 14, wherein the bottom surface is configured to mitigate partial discharge.

16. An energy storage system for storing electrical energy, the energy storage system comprising:
a plurality of cabinets, wherein each cabinet comprises:
a first energy storage module residing within the cabinet and having a positive terminal for receiving and delivering electrical energy;
a second energy storage module residing within the cabinet and having a negative terminal for receiving and delivering electrical energy;
a plurality of intermediate energy storage modules between the first and the second energy storage modules, wherein each of the first, the second, and the intermediate energy storage module comprises:
two or more rows of energy storage cells, with the energy storage cells being connected electrically in series, and wherein each row of energy storage cells has its own positive terminal and negative terminal;
at least two bulkheads having through-openings, wherein each through-opening receives a respective energy storage cell to support a row of the energy storage cells; and
a cooling system connected to the cabinet and configured to force air from one end of the cabinet to the second end of the cabinet;
and wherein:
the rows of energy storage cells within each energy storage module reside electrically in series;
the energy storage modules reside electrically in series between the positive terminal and the negative terminal of its respective cabinet;
forcing air from a first end of the cabinet to the second end of the cabinet causes air to flow across the energy storage cells; and
each of the plurality of cabinets resides electrically in series.

17. The energy storage system of claim 16, wherein the energy storage cells comprise batteries, capacitors, or a combination thereof.

18. The energy storage system of claim 16, further comprising:
a plurality of busbars, wherein:
each of a first portion of the busbars connects the negative terminal of a first energy storage module with the positive terminal of an adjacent second energy storage module; and
each of a second portion of the busbars connects the negative terminal of a first row of energy storage cells to the positive terminal of an adjacent second row of energy storage cells.

19. The energy storage system of claim 18, wherein:
the plurality of intermediate energy storage modules comprises at least two energy storage modules in each cabinet;
each of the plurality of energy storage modules resides on a rack, a shelf, or a rail within a cabinet; and
the negative terminal of each row of energy storage cells is in electrical connection with a positive terminal of an adjacent row of energy storage cells such that the rows of energy storage cells are in series.

20. The energy storage system of claim 19, wherein:
each row of energy storage cells comprises at least two capacitor cells positioned end-to-end; and
adjacent rows of energy storage cells are staggered so as not to be positioned along the same vertical plane.

21. The energy storage system of claim 20, further comprising:
at least one temperature sensor associated with each energy storage module;
a bypass switch associated with one or more energy storage modules; and
a module controller associated with each energy storage module, wherein each module controller is configured to (i) receive data related to voltage across each energy storage module, and (ii) receive data from at least one temperature sensor.

22. The energy storage system of claim 19, wherein:
each cabinet further comprises a cabinet controller configured to (i) receive data from each of the module controllers in its respective cabinet and, in response, (ii) generate bypass instructions for selected energy storage modules in its respective cabinet;
each energy storage module comprises at least two rows of energy storage cells; and
each row of energy storage cells within each energy storage module comprises at least two energy storage cells positioned end-to-end.

23. The energy storage system of claim 19, wherein the cooling system comprises a plurality of fans or a port for externally supplied forced air.

24. The energy storage system of claim 23, wherein:
the first end of the cabinet is opposite the second end of the cabinet;
the plurality of fans or the port reside at the first end of the cabinet.

25. The energy storage system of claim 20, wherein the cabinet comprises:
a first side wall;
a second side wall opposite the first side wall;
a door;
a third side wall opposite the door;
a top surface; and
a bottom surface;
wherein each of the side walls, the top and bottom surfaces, and the door are fabricated from a metal material, thereby forming a Faraday cage for the cabinet.

26. The energy storage system of claim 20, wherein each bulkhead comprises a reservoir residing below one or more of the through-openings configured to receive fluid that may escape from one or more of the energy storage cells.

27. The energy storage system of claim 16, wherein:
each cabinet represents an energy storage assembly; and
the plurality of cabinets comprises a first series of energy storage assemblies, forming a first string; and
the first string is in electrical communication with a power station, power sub-station, a micro-grid, or power conditioning equipment.

28. The energy storage system of claim 27, further comprising:
a string controller associated with a string of energy storage assemblies;
a plurality of cabinets comprising additional series of energy storage assemblies, forming additional strings;
a string controller associated with each additional string of energy storage assemblies;
wherein:
each string of energy storage assemblies resides electrically in parallel with one another; and
each string controller monitors all energy storage assemblies within its respective string;
